(19) United States
(12) Patent Application Publication
(10) Pub. No.: US 2003/0148039 A1
(43) Pub. Date: Aug. 7, 2003

(54) Method for producing coatings, adhesive layers or sealing layers for primed or unprimed substrates

(76) Inventors: Rainer Blum, Ludwigshafen (DE); Peter Keller, Elversberg (DE); Christopher Hilger, Munster (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/203,391

(22) PCT Filed: Mar. 1, 2001
(86) PCT No.: PCT/EP01/02281

(30) Foreign Application Priority Data
Mar. 1, 2000 (DE) 10009822

(51) Int. Cl. B05D 3/06

(52) U.S. Cl. 427/557; 427/558; 427/551; 427/385.5

(57) ABSTRACT

Process for producing coatings, adhesive films or seals which comprises

(1) applying coating materials, adhesives and sealing compounds comprising a constituent (A) which contains groups (a) containing bonds which can be activated with actinic radiation, and also photoinitiators (B), in the form of a water-free and solvent-free liquid or melt, a powder, a powder slurry, a dispersion or a solution in at least one organic solvent, dispersion or solution in an aqueous medium to and/or into a primed or unprimed substrate,

(2) drying the powder slurry layer or the layer of a dispersion or solution, or causing the layer of the melt to solidify or maintaining it in the melted state by heating,

(3) melting the solid layers by heating, and

(4) first irradiating the liquid layers resulting from step (1) of the process or the melted layers resulting from step (2) or (3) of the process in the melted state, during solidification and/or after solidification with near infrared radiation and then fully curing them with UV radiation and/or electron beams or fully curing them simultaneously with NIR radiation and UV radiation and/or electron beams.

The present invention relates to a novel process for producing coatings, adhesive films or seals for primed or unprimed substrates from free-radically and/or ionically curable coating materials, adhesives or sealing compounds by irradiation. The present invention further relates to the primed or unprimed substrates which carry at least one coating, adhesive film and/or seal produced by the novel process.

Free-radically and/or ionically curable coating materials, adhesives, and sealing compounds, but especially coating materials, which comprise at least one constituent (A) containing on average per molecule at least one group (a) containing at least one bond which can be activated with actinic radiation, and also the constituents (A) per se, have been known for a long time and are described in numerous patents. By way of example, reference is made to the European patent applications EP 0 928 800 A1, 0 636 669 A1, 0 410 242 A1, 0 783 534 A1, 0 650 978 A1, 0 650 979 A1, 0 650 985 A1, 0 540 884 A1, 0 568 907 A1, 0 054 505 A1, and 0 002 866 A1, the German patent applications DE 197 09 467 A1, 42 03 278 A1, 33 16 593 A1, 38 36 370 A1, 24 36 186 A1, and 20 03 579 B1, the international patent applications WO 97/46549 and 99/14254, and the American patents U.S. Pat. Nos. 5,824,373 A1, 4,675,234 A1, 4,634,602 A1, 4,424,252 A1, 4,208,313 A1, 4,163,810 A1, 4,129,488 A1, 4,064,161 A1, and 3,974,303 A1. Also known are coating materials which may be crosslinked thermally and with actinic radiation (cf. European patent application EP 0 844 286 A1), this being referred to by those in the art as dual cure.

The known coating materials may be present in the form of water-free and solvent-free liquids and melts (known as 100% systems), powders, dispersions of powders in water (known as powder slurries), or in the form of dispersions or solutions in at least one organic solvent. The same applies to the known adhesives and sealing compounds.

By actinic radiation, here and below, is meant electromagnetic radiation such as visible light, UV radiation or X-rays, but especially UV radiation, and corpuscular radiation such as electron beams.

Considered by themselves, coating materials, adhesives and sealing compounds which are curable with UV radiation lead to particular advantages, such as a short cycle time, low energy consumption for curing, and the possibility of coating, bonding, and sealing heat-sensitive substrates. However, they still always have quite specific disadvantages.

For instance, the known free-radically and/or ionically curable coating materials, adhesives, and sealing compounds comprise photoinitiators which when they are exposed to UV radiation form free radicals or cations which initiate the free-radical or ionic polymerization or crosslinking of the constituent (A) (cf. Römpp Lexikon Lacke und Druckfarben, Georg Thieme Verlag, Stuttgart, New York, 1998, “photoinitiators”, pages 444 to 446). A disadvantage here is that the photoinitiators give rise to decomposition products which have an unpleasant odor and/or are colored. This leads to unwanted emissions and to the yellowing of the coatings, adhesives and sealing compounds, which especially in the case of decorative coatings or bonded glass plates is unacceptable. Furthermore, the photoinitiators are in many cases expensive, and so their use may be of disadvantage economically. The deleterious effects described may be further intensified by the use of amine-type coinitiators. It would therefore be desirable to reduce the proportion of the photoinitiators in the coating materials without any accompanying deterioration in the crosslinking properties.

The photopolymerization may also be inhibited by atmospheric oxygen, which is why it is necessary either to work under air exclusion conditions or else to compensate for the inhibition by a very high concentration of initiator or by means of what are known as coinitiators. Nevertheless, it is in many cases impossible to realize the required surface properties.

The known pulverulent coating materials which are curable with UV radiation have the disadvantage that on temperature-sensitive substrates they cannot be melted fully prior to actual curing since otherwise the substrate is damaged. In many cases, therefore, the resulting coatings have a more or less structured surface, which, however, is unacceptable for particularly demanding applications, such as automotive OEM finishing, for instance.

There is therefore a need for a process for producing coatings, adhesive films or seals from free-radically and/or ionically curable coating materials, adhesives or sealing compounds of the type described above which should no longer have the above-described disadvantages of curing with actinic radiation but certainly should have its outlined advantages.

The Japanese patent applications JP 08 188 632 A1, 07 228 789 A1, 09 302 262 A1, 01 064 761 A1, 09 052 068 A1, and 08 206 584 A1, and the European patent applications EP 0 774 492 A1 and 0 889 363 A1 disclose free-radically and/or ionically curable coating materials which comprise constituents having photopolymerizable, olefinically unsaturated bonds.

These coating materials may be cured using near infrared (NIR) radiation. The prerequisite for this, however, is the use of dyes which absorb NIR radiation and so act as initiators of the photopolymerization. These dyes, however, lead to problems similar to those which occur in the case of conventional photoinitiators. These problems are particularly serious in decorative coatings or clearcoats, or in adhesive films between glass plates. Consequently, the principal application in the case, for example, of the compositions known from the European patent EP 0 889 363 A1 is in the field of the imagewise exposure for the production of photoresists, printing plates or holographic films, where a certain dye content is undisruptive in its effect and even, on the contrary, intensifies the image contrast.

The International patent application WO 99/47276 discloses a process for producing a coating on wood in which a thermoreactive powder coating material is applied to the wood surface, melted with NIR radiation, and pregelled or part-cured. Subsequently, a second layer of the powder coating material is applied, after which the as yet incompletely cured layers are crosslinked fully using NIR radiation. The use of UV radiation in this case is regarded as unsuitable.

The German patent application DE 197 36 462 A1 describes means and methods of thermoforming thermoplastics using NIR radiation. It does not go into the curing of free-radically and/or ionically curable coating materials, adhesives, and sealing compounds.

The German patent application DE 197 35 070 A1 discloses means of producing sheetlike printed products in which the printed products are dried thermally using NIR radiation. It does not mention the combined use of NIR and UV radiation.

The German patent applications, unpublished at the priority date of the present specification, of BASF Aktiengesellschaft with the title “Process for producing coatings, adhesive films or seals for primed or unprimed substrates” and the internal file reference O.Z. 0050/51087 or of BASF Coatings AG bearing the title “Process for producing coatings, adhesive films or seals for primed or unprimed substrates” and the internal file reference PAT 99 231 describe a process for producing coatings, adhesive films or seals for primed or unprimed substrates which comprises

(1) applying at least one free-radically and/or ionically curable coating material and/or adhesive and/or sealing compound comprising at least one constituent (A) containing on average per molecule at least one group (a) containing at least one bond which can be activated with actinic radiation, in the form of

(1.1) a water-free and solvent-free liquid or melt,

(1.2) a powder,

(1.3) a powder slurry,

(1.4) a dispersion or a solution in at least one organic solvent, or

(1.5) a dispersion or a solution in an aqueous medium

to and/or into the primed or unprimed substrate,

(2) drying the resultant powder slurry layer (1.3) or the resultant layer of a dispersion or a solution (1.4) or (1.5) or causing the resultant layer of the melt (1.1) to solidify or maintaining it in a melted state by heating,

(3) melting, by heating, the resultant solid layer (1.2), (1.3), (1.4) or (1.5), and

(4) curing the liquid layer resulting from step (1) of the process or the melted layer resulting from step (2) or (3) of the process

(4.1) in the liquid or melted state,

(4.2) during solidification, and/or

(4.3) after solidification with near infrared (NIR) radiation.

It is an object of the present invention to meet the need described above and to discover a novel process for producing coatings, adhesive films, and seals from free-radically and/or ionically curable coating materials, adhesives, and sealing compounds which are known per se which no longer has the disadvantages of the prior art, such as the yellowing and odor nuisance originating from the use of comparatively large amounts of photoinitiators, and which does not use dyes which absorb NIR radiation. The novel process should continue to have the particular advantages of the known coating materials, adhesives, and sealing compounds curable with actinic radiation, such as a short cycle time, low energy consumption on curing, and the possibility of coating, bonding, and sealing heat-sensitive substrates. The novel process should not least permit the production of smooth, structureless coatings even from powder coating materials curable with actinic radiation.

The invention accordingly provides the novel process for producing coatings, adhesive films or seals for primed or unprimed substrates, which comprises

(1) applying at least one free-radically and/or ionically curable coating material and/or adhesive and/or sealing compound comprising

(A) at least one constituent containing on average per molecule at least one group (a) containing at least one bond which can be activated with actinic radiation, and

(B) at least one photoinitiator,

in the form of

(1.1) a water-free and solvent-free liquid or melt,

(1.2) a powder,

(1.3) a powder slurry,

(1.4) a dispersion or a solution in at least one organic solvent, or

(1.5) a dispersion or a solution in an aqueous medium

to and/or into the primed or unprimed substrate,

(2) drying the resultant powder slurry layer (1.3) or the resultant layer of a dispersion or a solution (1.4) or (1.5) or causing the resultant layer of the melt (1.1) to solidify or maintaining it in a melted state by heating,

(3) melting, by heating, the resultant solid layer (1.2), (1.3), (1.4) or (1.5), and

(4) first irradiating the liquid layer resulting from step (1) of the process or the melted layer resulting from step (2) or (3) of the process

(4.1) in the liquid or melted state,

(4.2) during solidification, and/or

(4.3) after solidification

with near infrared (NIR) radiation and then fully curing it with UV radiation and/or electron beams or fully curing it simultaneously with NIR and UV radiation and/or electron beams.

In the text below, the novel process for producing coatings, adhesive films or seals for primed or unprimed substrates is referred to as the “process of the invention”.

Further subject matter of the invention will emerge from the description.

In the light of the prior art it was surprising and unforeseeable for the skilled worker that the object on which the present invention is based might be achieved by means of the process of the invention. A particular surprise was that by means of the process of the invention it is possible to subject conventional coating materials, adhesives, and sealing compounds to free-radical and/or ionic crosslinking without the presence of NIR-absorbing dyes or the commonly used amounts of photoinitiators. Even more of a surprise was the extremely broad usefulness of the process of the invention, especially in the field of the coating of primed and unprimed substrates. A further surprise is that by means of the process of the invention it was possible to produce coatings with a smooth and structureless surface, even from pulverulent coating materials.

The process of the invention serves for the coating, bonding and/or sealing of primed or unprimed substrates.

Suitable substrates are all surfaces of articles that are amenable to curing of the layers of coating materials, adhesives and/or sealing compounds present thereon under the combined application of actinic radiation and NIR radiation; examples include articles made of metals, plastics, wood, ceramic, stone, textile, fiber composites, leather, glass, glass fibers, glass wool, rock wool, mineral-bound and resin-bound building materials, such as plasterboard, cement slabs, and bricks. Accordingly, the process of the invention is highly suitable for the coating, bonding or sealing of constructions, doors, windows, motor vehicle bodies, furniture, and components for private or industrial use, such as radiators, domestic appliances, small metal parts, hub caps, wheel rims, coils, freight containers, and electrical components, such as windings of electrical motors.

The metallic substrates employed in this context may have a primer system, in particular a cathodically or anodically deposited and heat-cured electrocoat. If desired, the electrocoat may also have been coated with an antistonechip primer or with a primer-surfacer.

The process of the invention is also used in particular for the coating, bonding or sealing of primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM, and UP (abbreviations to DIN 7728T1). The plastics may of course also be polymer blends, modified plastics, or fiber reinforced plastics. Nonfunctionalized and/or nonpolar plastics surfaces may be subjected prior to coating in a known manner to a pretreatment with a plasma or by flaming and/or may be coated with a water-based primer system comprising a hydroprimer.

In step (1) of the process of the invention, at least one coating material, adhesive and/or sealing compound is applied to and/or into the substrate described above.

The application may take place by any of the customary application methods, such as spraying, knife coating, brushing, flow coating, dipping, impregnating, trickling or rolling, for example. The substrate to be coated, bonded or sealed may itself be at rest, with the application equipment or unit being moved. However, it is also possible for the substrate to be coated, bonded or sealed, in particular a coil, to be moved, with the application unit being at rest relative to the substrate or being moved appropriately.

Preference is given to the use of spray application methods, such as, for example, compressed-air spraying, airless spraying, high-speed rotation, electrostatic spray application (ESTA), alone or in conjunction with hot spray application such as hot-air spraying, for example. Application may take place at temperatures of max. 70 to 80° C., so that appropriate application viscosities are attained without any change or damage to the coating material, adhesive or sealing compound and its overspray (which may be intended for reprocessing) during the short period of thermal stress. Hot spraying, for instance, may be configured in such a way that the coating material, adhesive or sealing compound is heated only very briefly in the spray nozzle or shortly before the spray nozzle.

The spray booth used for application may be operated, for example, with a circulation system, which may be temperature-controllable, and which is operated with an appropriate absorption medium for the overspray, an example of such a medium being the coating material itself that is to be used in accordance with the invention.

The coating material, adhesive and sealing compound may be in the form of a water-free and solvent-free liquid or melt (1.1). In the context of the present invention, a liquid is a substance which is liquid at room temperature. Conversely, a melt is a substance which is solid at room temperature and which liquefies only above room temperature. Coating materials, adhesives and sealing compounds (1.1) of this kind are referred to by those in the art as 100% systems.

The coating material, adhesive or sealing compound may also be in the form of a powder (1.2). Coating materials (1.2) of this kind are conventionally referred to by those in the art as powder coating materials.

However, the pulverulent coating materials, adhesives, and sealing compounds may also be present as a dispersion in an aqueous medium (1.3). The aqueous medium may comprise water alone or water in which low molecular mass, oligomeric and/or polymeric, gaseous, liquid and/or solid, organic and/or inorganic substances, such as the additives (C) described below, for example, have been dissolved or dispersed. The critical factor here is that these substances are only present in an amount which does not destroy the aqueous nature of the aqueous medium. Coating materials (1.3) of this kind are conventionally referred to by those in the art as powder slurries.

Furthermore, the coating materials, adhesives, and sealing compounds may be present in the form of a dispersion or solution in at least one organic solvent (1.5). Coating materials (1.5) of this kind are conventionally referred to by those in the art as conventional coating materials.

Not least, the coating materials, adhesives, and sealing compounds may be present in the form of a dispersion or solution in at least one aqueous medium. Coatings of this kind are conventionally referred to by those in the art as aqueous coating materials.

In the context of the present invention, in step (2) of the process the resultant powder slurry layer (1.3) or the resultant layer of a dispersion or a solution (1.4) or (1.5) is dried.

Where coating materials, adhesives or sealing compounds (1.1) in the form of a melt are used, the resultant layer (1.1) is caused to solidify or is maintained in a melted state by heating. In this case, the layer (1.1) may be heated in a customary and known manner with hot air, in forced-air ovens for example, or with conventional infrared lamps. In accordance with the invention it is of advantage in this step (2) too to use NIR radiation.

Where coating materials, adhesives or sealing compounds (1.2), (1.3), (1.4) or (1.5) are used, in step (3) of the process the solid layer (1.2), (1.3), (1.4) and (1.5) resulting from step (2) is melted by heating. Here again, the layer (1.2), (1.3), (1.4) or (1.5) may be heated in a customary and known manner with hot air, in forced-air ovens for example, or with conventional infrared lamps. In accordance with the invention it is of advantage in this step (3) too to use NIR radiation.

In step (4) of the process of the invention, the liquid layer (1.1) resulting from step (1) or the melted layer (1.2), (1.3), (1.4) or (1.5) resulting from step (2) or (3) in a melted state, during solidification and/or after solidification is first of all irradiated with near infrared (NIR) radiation. This may be accompanied already by partial or complete crosslinking of the complementary reactive functional groups described below that are suitable for thermal crosslinking, provided they are present in the coating materials, adhesives, and sealing compounds for use in accordance with the invention. Furthermore, crosslinking of the coating materials, adhesives, and sealing compounds for use in accordance with the invention by way of the bonds described below which can be activated with actinic radiation may occur. In accordance with the invention it is of advantage if no crosslinking or only partial crosslinking, preferably partial crosslinking, occurs.

In accordance with the invention it is of advantage to use NIR radiation of a wavelength for which the solid layers (1.2), (1.3), (1.4) and (1.5), the liquids and melts (1.1), and the melts resulting from step (4) of the process are partially transparent. Particular advantages result if from 20 to 80%, in particular from 40 to 70%, of the irradiated NIR radiation is absorbed. This is preferably achieved by means of NIR radiation of a wavelength of from 600 to 1400 nm, in particular from 750 to 1100 nm, and so it is this which is used with very particular preference for the process of the invention.

In accordance with the invention, the layers exposed to NIR radiation are subsequently fully cured with UV radiation and/or electron beams, so resulting in the coatings, adhesive films, and seals of the invention.

In a further variant of the process of the invention, the layers described above are fully cured simultaneously with NIR radiation and with UV radiation and/or electron beams.

In the majority of cases, the first variant of the process of the invention is of advantage and is therefore employed with preference.

Viewed in terms of its method and apparatus, the exposure to NIR radiation in step (4) of the process has no special features but instead takes place with the aid of commercially available lamps which emit a high proportion of their radiation in the near infrared. Examples of suitable lamps are halogen lamps with a high coiled-filament temperature, as sold, for example, by the company Ushio Inc., Tokyo, Japan, or the company IndustrieService, Germany.

In this case, advantageously, using optical devices, the NIR radiation may be guided and focused so as to achieve a temperature distribution which is adapted to the melting and curing characteristics of the coating materials, adhesives, and sealing compounds. Moreover, the radiative energy acting on the applied coating materials, adhesives, and sealing compounds, and/or the wavelength of the NIR radiation, may be precisely adjusted by electrical regulation of the lamps and/or by optical filter devices. For further details, reference is made to the German patent DE 197 36 462 A1, column 1, line 52 to column 2, line 33.

The skilled worker is therefore easily able to determine the parameters advantageous for the case in hand on the basis of his or her knowledge in the art, possibly with the assistance of simple preliminary rangefinding experiments.

Similarly, exposure to UV radiation and/or electron beams (actinic radiation) has no special features in terms of method and apparatus, but is carried out using the customary and known equipment and radiation doses.

In the case of curing with actinic radiation, it is preferred to employ a dose of from 1000 to 2000, more preferably from 1100 to 1900, with particular preference from 1200 to 1800, with very particular preference from 1300 to 1700, and in particular from 1400 to 1600 mJ/cm². If desired, this curing may be supplemented with actinic radiation from other radiation sources. In the case of electron beams, it is preferred to operate under an inert gas atmosphere. This may be ensured, for example, by supplying carbon dioxide and/or nitrogen directly to the surface of the relevant layer that is to be cured. In the case of curing with UV radiation as well it is possible to operate under inert gas in order to prevent the formation of ozone.

Curing with actinic radiation is carried out using the customary and known radiation sources and optical auxiliary measures. Examples of suitable radiation sources are flash lamps from the company VISIT, high or low pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape, as are envisaged for automobile bodies, the regions not accessible to direct radiation (shadow regions) such as cavities, folds and other structural undercuts may be (partly) cured using pointwise, small-area or all-round emitters, in conjunction with an automatic movement device for the exposure of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom 1984.

Curing here may take place in stages, i.e., by multiple exposure to light or actinic radiation. It may also take place alternatingly, i.e., by curing alternately with UV radiation and electron beams.

The resultant coatings, adhesive films, and seals of the invention may also be aftertreated with NIR radiation and/or heat.

The coating materials, adhesives, and sealing compounds to be employed in the process of the invention comprise at least one constituent (A) containing on average per molecule at least one, preferably at least two, group(s) (a) containing at least one bond which can be activated with actinic radiation.

In the context of the present invention, a bond which can be activated with actinic radiation means a bond which, on exposure to actinic radiation, becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Also suitable are bonds which are able to enter into photoreactions which proceed in accordance with hydrogen abstraction mechanisms, such as reactions of the Norrish B type, for instance. Of the abovementioned bonds, the carbon-carbon double bonds are particularly advantageous and are therefore used with very particular preference in accordance with the invention. For the sake of brevity, they are referred to below as “double bonds”.

Accordingly, the group (a) preferred in accordance with the invention contains one double bond or two, three or four double bonds. Where more than one double bond is used, the double bonds may be conjugated. In accordance with the invention, however, it is of advantage if the double bonds are present in isolation, in particular each terminally, in the group (a). It is of particular advantage in accordance with the invention to use two double bonds, especially one double bond.

The constituent (A) further comprises on average at least one group (a). This means that the functionality of the constituent (A) is integral, i.e., for example, equal to one, two, three, four, five or more, or nonintegral, i.e., for example, equal to 1.1 to 10.5 or more. Which functionality is chosen depends firstly on the stoichiometric ratios of the starting materials of the constituents (A), which secondly depend in turn on their intended applications.

Where on average more than one group (a) per molecule is employed, the at least two groups (a) are structurally different from one another or of identical structure.

Where they are structurally different from one another, this means in the context of the present invention that two, three, four or more, but especially two, groups (a) are used which derive from two, three, four or more, but especially two, monomer classes.

Examples of suitable groups (a) are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, but especially acrylate groups.

The constituent (A) is preferably a solid, since this results in coating materials, adhesives, and sealing compounds (1.1) or (1.3) which are particularly good for the process of the invention. The solid may be amorphous, partially crystalline, or crystalline. Which variant is used for the process of the invention depends on the requirements of the individual case.

Further particular advantages result if the solvent-free or water-free constituent (A) has a melting range or a melting point in the temperature range from 40 to 130° C. In accordance with the invention it is further of advantage if the solvent-free or water-free constituent (A) has a melt viscosity at 130° C. of from 50 to 20 000 mPas.

Preferably, the groups (a) are attached to the parent structure of the constituent (A) by way of urethane, urea, allophanate, ester, ether, and/or amide groups. Urethane groups are particularly preferred. The following two linking structures I and II come into consideration for this purpose:

parent structure-NH—C(O)—O-group (a) (I) and

parent structure-O—(O)C—NH-group (a) (II).

The constituent (A) may contain both linking structures I and II alongside one another, or only one of them. In general, the structure I is of advantage, owing to the larger number of starting materials available and their comparatively greater ease of preparation, and is therefore employed with preference in accordance with the invention.

The groups (a) are attached terminally and/or laterally to the parent structure. Which type of attachment is chosen depends in particular on whether the functional groups are present terminally or laterally in the parent structure with which the starting materials of the groups (a) are able to react. In many cases, terminal groups (a) are more reactive than lateral groups (a), owing to the absence of steric shielding, and are therefore used with preference. On the other hand, however, the reactivity of the solid of the invention may be specifically controlled by way of the ratio of terminal to lateral groups (a), which is a further particular advantage of the solid for use in accordance with the invention.

The parent structure of the constituent (A) is of low molecular mass, oligomeric and/or polymeric. That is to say that the constituent (A) is a low molecular mass compound, an oligomer or a polymer. Or else the constituent (A) has low molecular mass and oligomeric, low molecular mass and polymeric, oligomeric and polymeric, or low molecular mass, oligomeric, and polymeric parent structures. In other words, it is a mixture of low molecular mass compounds and oligomers, of low molecular mass compounds and polymers, of oligomers and polymers, or of low molecular mass compounds, oligomers, and polymers.

In the context of the present invention, oligomers are resins whose molecule contains at least 2 to 15 repeating monomer units. In the context of the present invention, polymers are resins whose molecule contains at least 10 repeating monomer units. For further details of these terms, reference is made to Römpp, op. cit., page 425: “oligomers”.

The low molecular mass, oligomeric or polymeric parent structure comprises or consists of aromatic, cycloaliphatic and/or aliphatic structures or building blocks. It preferably comprises or consists of cycloaliphatic and/or aliphatic structures, especially cycloaliphatic and aliphatic structures.

Examples of suitable aromatic structures are aromatic and heteroaromatic rings, especially benzene rings.

Examples of cycloaliphatic structures are cyclobutane, cyclopentane, cyclohexane, cycloheptane, norbornane, camphane, cyclooctane or tricyclodecane rings, especially cyclohexane rings.

Examples of aliphatic structures are linear or branched alkyl chains having 2 to 20 carbon atoms, or chains as result during the addition (co)polymerization of olefinically unsaturated monomers.

The parent structure, especially the oligomeric and/or polymeric parent structure, may further comprise olefinically unsaturated double bonds.

The parent structure, especially the oligomeric and/or polymeric parent structure, is of linear, branched, hyperbranched or dendrimeric structure.

It may comprise polyvalent, especially divalent, functional groups (b) by means of which the above-described structures or building blocks are linked with one another to the parent structure. These are generally selected in such a way that they do not disrupt, let alone completely prevent, the reactions initiated by the NIR radiation. Examples of suitable functional groups are ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, urethane, hydrazide, urea, thiourea, carbonyl, thiocarbonyl, sulfone, sulfoxide or siloxane groups. Of these groups, the ether, carboxylate, carbonate, carboxamide, urea, urethane, imide and carbonate groups, especially the carboxylate and the urethane groups, are of advantage and are therefore used with preference.

Advantageous oligomeric and polymeric parent structures are therefore derived from random, alternating and/or block, linear, branched, hyperbranched, dendrimeric and/or comb addition (co)polymers of ethylenically unsaturated monomers, polyaddition resins and/or polycondensation resins. For further details of these terms, reference is made to Römpp, op. cit., page 457: “polyaddition” and “polyaddition resins (polyadducts)”, and also pages 463 and 464: “polycondensates”, “polycondensation”, and “polycondensation resins”.

Examples of highly suitable addition (co)polymers are poly(meth)acrylates and partially saponified polyvinyl esters.

Examples of highly suitable polyaddition resins and/or polycondensation resins are polyesters, alkyds, polyurethanes, polyester-polyurethanes, polylactones, polycarbonates, polyethers, polyester-polyethers, epoxy resin-amine adducts, polyureas, polyamides or polyimides. Of these, the polyesters, polyester-polyethers, polyurethanes and polyester-polyurethanes are particularly advantageous and are therefore used with very particular preference in accordance with the invention.

The parent structure may carry lateral reactive functional groups (c) which with reactive functional groups (c) of their own kind or with other, complementary, functional groups (d) are able to enter into thermally initiated crosslinking reactions. In this case, the complementary functional groups (c) and (d) may be present in one and the same parent structure, which is the case with what are, known as self-crosslinking systems. Alternatively, the functional groups (d) may be present in a further constituent, materially different from the solid of the invention, an example of such a constituent being a crosslinking agent (C), which is the case with what are known as externally crosslinking systems. For further details, reference is made to Römpp, op. cit., pages 274 to 276: “Curing”. Reactive functional groups (c) and (d) are used in particular when the constituent (a) is to be curable thermally as well (dual cure). They are selected so that they do not disrupt, let alone entirely prevent, the polymerization or crosslinking reaction of the double bonds of the groups (a) that is initiated by the NIR radiation and also the actinic radiation. However, reactive functional groups (c) and (d) which undergo addition onto olefinically unsaturated double bonds may be used as well in minor amounts—that is, amounts which are not disruptive.

Examples of suitable complementary reactive functional groups (c) and (d) are evident from the following overview.

Overview: Complementary reactive functional groups (c) and (d)

| | | |
|---|---|---|
| (c) | and | (d) |
| | or | |
| (d) | and | (c) |
| —SH | | —C(O)—OH |
| —NH₂ | | —C(O)—O—C(O)— |
| —OH | | —NCO |
| —O—(CO)—NH—(CO)—NH₂ | | —NH—C(O)—OR |
| —O—(CO)—NH₂ | | —CH₂—OH |
| | | —CH₂—O—CH₃ |
| | | —NH—CH₂OH |
| | | —NH—CH₂OR |
| | | —N(CH₂OH)₂ |
| | | —N(CH₂OR)₂ |
| | | —NH—C(O)—CH(—C(O)OR)₂ |
| | | —NH—C(O)—CH(—C(O)OR)(—C(O)—R) |
| | | —NH—C(O)—NR¹R² |
| | | ═Si(OR)₂ |
| | | 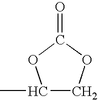 |
| | | 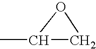 |
| —C(O)—OH | | 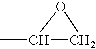 |
| | | —C(O)—N(CH₂CH₂OH)₂ |
| —O—C(O)—CR═CH₂ | | —OH |
| —O—CR═CH₂ | | —NH₂ |
| | | —C(O)—CH₂—C(O)—R |

In the overview, the variable R stands for an acyclic or cyclic aliphatic radical, an aromatic radical and/or an aromatic-aliphatic (araliphatic) radical; the variables R¹ and R² stand for identical or different aliphatic radicals or are linked with one another to form an aliphatic or heteroaliphatic ring.

Where the reactive complementary groups (c) and/or (d) are used, they are preferably present in the constituent (A) in an amount corresponding to an average of from 1 to 4 groups per molecule.

The parent structure may further comprise chemically bonded stabilizers (e). Where they are used too, they are present in the constituent (A) in an amount of from 0.01 to 1.0 mol %, preferably from 0.02 to 0.9 mol %, more preferably from 0.03 to 0.85 mol %, with particular preference from 0.04 to 0.8 mol %, with very particular preference from 0.05 to 0.75 mol %, and in particular from 0.06 to 0.7 mol %, based in each case on the double bonds present in the constituent (A).

The chemically bonded stabilizer (e) comprises compounds which are or which donate sterically hindered nitroxyl radicals (>N—O.) which scavenge free radicals in the modified Denisov cycle.

Examples of suitable chemically bonded stabilizers (e) are HALS compounds, preferably 2,2,6,6-tetraalkyl-piperidine derivatives, especially 2,2,6,6-tetramethylpiperidine derivatives, whose nitrogen atom is substituted by an oxygen atom or by an alkyl, alkylcarbonyl or alkyl ether group. For further details, reference is made to the textbook “Lackadditive” [Additives for coatings] by Johan Bieleman, Wiley-VCH, Weinheim, N.Y., 1998, pages 293 to 295.

Examples of suitable starting materials (e) for the introduction of the chemically bonded stabilizers (f) are HALS compounds, preferably 2,2,6,6-tetraalkylpiperidine derivatives, especially 2,2,6,6-tetramethylpiperidine derivatives, whose nitrogen atom is substituted by an oxygen atom or by an alkyl, alkylcarbonyl or alkyl ether group, and which contain an isocyanate group or an isocyanate-reactive functional group (c) or (d), in particular a hydroxyl group. One example of an especially suitable starting material (e) is the nitroxyl radical 2,2,6,6-tetramethyl-4-hydroxypiperidine N-oxide.

The preparation of the parent structures for use in accordance with the invention has no special features in terms of its method but instead takes place with the aid of the customary and known synthesis methods of low-molecular organic chemistry and/or of polymer chemistry. As regards the oligomeric and/or polymeric parent structures which are very particularly preferred in accordance with the invention and which are derived from polyesters, polyester-polyethers, polyurethanes and polyester-polyurethanes, but especially from the polyurethanes and polyester-polyurethanes, the customary and known methods of polyaddition and/or polycondensation are employed. By way of example, reference is made to the above-cited European patent applications EP 0 928 800 A1, 0 636 669 A1, 0 410 242 A1, 0 783 534 A1, 0 650 978 A1, 0 650 979 A1, 0 650 985 A1, 0 540 884 A1, 0 568 907 A1, 0 054 505 A1, and 0 002 866 A1, the German patent applications DE 197 09 467 A1, 42 03 278 A1, 33 16 593 A1, 38 36 370 A1, 24 36 186 A1, and 20 03 579 B1, the international patent applications WO 97/46549 and 99/14254, and the American patents U.S. Pat. Nos. 4,675,234 A1, 4,634,602 A1, 4,424,252 A1, 4,208,313 A1, 4,163,810 A1, 4,129,488 A1, 4,064,161 A1, and 3,974,303 A1.

The coating materials, adhesives, and sealing compounds used in the process of the invention comprise at least one photoinitiator (B). Examples of suitable photoinitiators (B) are described in Römpp, op. cit., “photoinitiators”, pages 444 to 446. The photo-initiators (B) may be used in customary and known amounts: for example in the amounts disclosed in the European patent applications cited at the outset EP 0 928 800 A1, 0 636 669 A1, 0 410 242 A1, 0 783 534 A1, 0 650 978 A1, 0 650 979 A1, 0 650 985 A1, 0 540 884 A1, 0 568 907 A1, 0 054 505 A1, and 0 002 866 A1, the German patent applications DE 197 09 467 A1, 42 03 278 A1, 33 16 593 A1, 38 36 370 A1, 24 36 186 A1, and 20 03 579 B1, the International patent applications WO 97/46549 and 99/14254, and the American patents U.S. Pat. Nos. 4,675,234 A1, 4,634,602 A1, 4,424,252 A1, 4,208,313 A1, 4,163,810 A1, 4,129,488 A1, 4,064,161 A1, and 3,974,303 A1. It proves, however, to be a particular advantage of the process of the invention that the photoinitiators may be used in amounts smaller than those which are customary and known without any deterioration in the crosslinking properties: in particular, without the crosslinking rate falling.

The coating materials, adhesives, and sealing compounds used in the process of the invention may further comprise at least one crosslinking agent (C) containing on average per molecule at least two complementary reactive functional groups (c) or (d). Examples of suitable crosslinking agents (C) for the thermal curing are amino resins, resins or compounds containing anhydride groups, resins or compounds containing epoxide groups, tris(alkoxycarbonylamino)triazines, resins or compounds containing carbonate groups, blocked and/or unblocked polyisocyanates, beta-hydroxyalkylamides, and compounds containing on average at least two groups capable of transesterification, examples being reaction products of malonic diesters and polyisocyanates or of esters and partial esters of polyhydric alcohols of malonic acid with monoisocyanates, as described in the European patent EP-A-0 596 460. Where particularly reactive crosslinking agents (C) such as polyisocyanates are used, they are generally not added until shortly before the application of the coating materials, adhesives and sealing compounds in question, which in that case are referred to by those in the art as two-component systems. Systems known as one-component systems result if less reactive crosslinking agents (C) are present from the outset in the coating materials, adhesives, and sealing compounds. The nature and amount of the crosslinking agents (C) are guided primarily by the complementary reactive groups (c) present in the constituents (A) and by the number of these groups.

The coating materials, adhesives, and sealing compounds used in the process of the invention may further comprise, moreover, at least one additive (D) selected from the group consisting of color and/or effect pigments, organic and inorganic, transparent or opaque fillers, nanoparticles, reactive diluents curable thermally and/or with actinic radiation, low-boiling organic solvents and high-boiling organic solvents (“long solvents”), water, UV absorbers, light stabilizers, free-radical scavengers, thermolabile free-radical initiators, thermal crosslinking catalysts, photoinitiators, devolatilizers, slip additives, polymerization inhibitors, defoamers, emulsifiers, wetting agents, dispersants, adhesion promoters, leveling agents, film-forming auxiliaries, sag control agents (SCAs), rheology control additives (thickeners), flame retardants, siccatives, driers, antiskinning agents, corrosion inhibitors, waxes, and flatting agents.

The nature and amount of the additives (D) are guided by the intended use of the coatings, adhesive films, and seals produced with the aid of the process of the invention.

Where, for example, the process of the invention is used to produce primers, primer-surfacer coats, antistonechip primers, solid-color topcoats or basecoats, the coating material in question comprises color and/or effect pigments (D) and also, if desired, opaque fillers. Here, the process of the invention allows complete crosslinking of the pigmented coated materials in question despite their in some cases high pigment content. This constitutes a further particular advantage of the process of the invention. Where the process of the invention is used, for example, to produce clearcoats, these additives (D) are of course not present in the coating material in question.

Examples of suitable effect pigments (D) are metal flake pigments such as commercially customary aluminum bronzes, aluminum bronzes chromated in accordance with DE-A-36 36 183, and commercially customary stainless steel bronzes, and also nonmetallic effect pigments, such as pearlescent pigment and interference pigment, for example. For further details, reference is made to Römpp, op. cit., page 176, “effect pigments” and pages 380 and 381, “metal oxide-mica pigments” to “metal pigments”.

Examples of suitable inorganic color pigments (D) are titanium dioxide, iron oxides, Sicotrans yellow, and carbon black. Examples of suitable organic color pigments (D) are thioindigo pigments, indanthrene blue, Cromophthal red, Irgazine orange, and Heliogen green. For further details, reference is made to Römpp, op. cit., pages 180 and 181, “iron blue pigments” to “black iron oxide”, pages 451 to 453, “pigments” to “pigment volume concentration”, page 563, “thioindigo pigments”, and page 567, “titanium dioxide pigments”.

Examples of suitable organic and inorganic fillers (D) are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, or wood flour. For further details, reference is made to Römpp, op. cit., pages 250 ff, “fillers”.

Examples of suitable thermally curable reactive diluents (D) are positionally isomeric diethyl-octanediols or hydroxyl-containing hyperbranched compounds or dendrimers.

Examples of suitable reactive diluents (D) curable with actinic radiation are those described in Römpp, op. cit., on page 491 under the entry on “reactive diluents”.

Examples of suitable low-boiling organic solvents (D) and high-boiling organic solvents (D) (“long solvents”) are ketones such as methyl ethyl ketone or methyl isobutyl ketone, esters such as ethyl acetate or butyl acetate, ethers such as dibutyl ether or ethylene glycol, diethylene glycol, propylene glycol, dipropylene glycol, butylene glycol or dibutylene glycol dimethyl, diethyl or dibutyl ethers, N-methylpyrrolidone or xylenes, or mixtures of aromatic hydrocarbons such as Solvent Naphtha® or Solvesso®.

Examples of suitable light stabilizers (D) are HALS compounds, benzotriazoles or oxalanilides.

Examples of suitable thermolabile free-radical initiators (D) are organic peroxides, organic azo compounds or C—C-cleaving initiators such as dialkyl peroxides, peroxocarboxylic acids, peroxodicarbonates, peroxide esters, hydroperoxides, ketone peroxides, azo dinitriles or benzpinacol silyl ethers.

Examples of suitable crosslinking catalysts (D) are dibutyltin dilaurate, lithium decanoate or zinc octoate.

An example of a suitable devolatilizer (D) is diazadicycloundecane.

Examples of suitable emulsifiers (D) are nonionic emulsifiers, such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols.

Examples of suitable wetting agents (D) are siloxanes, fluorine compounds, carboxylic monoesters, phosphates, polyacrylic acids and their copolymers, or polyurethanes.

An example of a suitable adhesion promoter (D) is tricyclodecanedimethanol.

Examples of suitable film-forming auxiliaries (D) are cellulose derivatives.

Examples of suitable transparent fillers (D) are those based on silica, alumina or zirconium oxide; for further details, reference is made to Römpp, op. cit., pages 250 to 252.

Examples of suitable Sag control agents (D) are ureas, modified ureas and/or silicas, as described for example in the references EP-A-192 304, DE-A-23 59 923, DE-A-18 05 693, WO 94/22968, DE-C-27 51 761, WO 97/12945 or “farbe + lack”, 11/1992, pages 829 ff.

Examples of suitable rheology control additives (D) are those known from the patents WO 94/22968, EP-A-0 276 501, EP-A-0 249 201 or WO 97/12945; crosslinked polymeric microparticles, as disclosed for example in EP-A-0 08 127; inorganic phyllosilicates such as aluminum magnesium silicates, sodium magnesium and sodium magnesium fluorine lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, poly-vinylpyrrolidone, styrene-maleic anhydride or ethylene-maleic anhydride copolymers and their derivatives or hydrophobically modified ethoxylated urethanes or polyacrylates.

An example of a suitable flatting agent (D) is magnesium stearate.

Further examples of the above-recited additives (D) and also examples of suitable UV absorbers, free-radical scavengers, leveling agents, flame retardants, siccatives, driers, antiskinning agents, corrosion inhibitors and waxes (D) are described in detail in the textbook “Lackadditive” by Johan Bieleman, Wiley-VCH, Weinheim, N.Y., 1998.

The additives (D) are used in customary and known, effective amounts.

The preparation of the coating materials, adhesives, and sealing compounds has no special features but instead takes place in a customary and known manner by mixing of the above-described constituents (A) and (B) and also, if desired, (C) and (D) in suitable mixing equipment such as stirred vessels, dissolvers, stirred mills or extruders in accordance with the techniques which are suitable for the preparation of the respective coating materials, adhesives, and sealing compounds (1.1), (1.2), (1.3), (1.4) or (1.5).

The coatings produced by means of the process of the invention, especially the single-coat and multicoat clearcoats and color and/or effect coatings, are of the very highest optical quality as regards color, effect, gloss, and DOI (distinctiveness of the reflected image), have a smooth, structureless, hard, flexible, and scratch-resistant surface, are free of odor and resistant to weathering, chemicals and etching, do not yellow, and display no cracking or delamination of the coats.

The adhesive films and seals produced by means of the process of the invention are long-lived, even under extreme climatic conditions, and are of high bond strength and sealing capacity, respectively.

The primed or unprimed substrates which have been provided by the procedure of the invention with at least one coating, adhesive film and/or seal therefore have a particularly long service life and a particularly high utility, making them especially attractive both technically and economically to manufacturers, applicators and end users.

### EXAMPLES AND COMPARATIVE EXPERIMENTS

### Examples 1 and 2 and Comparative Experiments C1 and C2

The Production of Coatings on Furniture Chipboard and Fiberboard by the Inventive Process (Examples 1 and 2) and Conventionally (Comparative Experiments C1 and C2)

For the examples and comparative experiments, a powder clearcoat material is prepared from the following commercial constituents:

74 parts by weight of unsaturated polyester resin (Uralac® XP 3125 from DSM),

26 parts by weight of a divinylurethane (Uralac® ZW 3307 W from DSM),

1 part by weight of benzoin,

0.5 part by weight of leveling assistant (BYK® 361 from Byk Chemie), and

2.5 parts by weight of photoinitiator (Irgacure® D 2954 from Ciba Specialty Chemicals).

The constituents were mixed initially and then homogenized 120° C. in a laboratory extruder. Following the discharge and cooling of the melt, the solidified melt was ground and sieved to a particle size of max. 70 μm. The resultant UV-curable powder coating material was scattered using a sieve onto test panels made of MDF (medium density fiberboard; fiberboard panels; example 1 and comparative experiment C1) and FCB (furniture chipboard panels; example 2 and comparative experiment C2). During application, the test panels were on a balance and the amount of powder applied in each case was such as to give a coat thickness after melting of 80 μm.

For the UV exposure, a laboratory traversal unit from the company IST was used which was equipped with two UV lamps of type M400-U2H. In all examples and comparative experiments, the traversal speed was 10 m/min.

For the comparative experiments C1 and C2, a longwave IR lamp (IR lamp from Elstein, model IR 2000, emission maximum at 5000 nm) was mounted directly at the entrance of the laboratory traversal unit.

For examples 1 and 2, an NIR lamp (NIR lamp from IndustrieService, model MPP 120-0, emission maximum at 850 nm) was positioned at the same point.

Both arrangements were used to melt the powder coating layers. The surface temperatures of the coating layers were measured using an IR sensor.

The results obtained for comparative experiments C1 and C2 are given in table 1. The results obtained for examples 1 and 2 are given in table 2. A comparison of the results underscores the fact that the coatings produced by the procedure of the invention far exceed those obtained conventionally in the quality of leveling. Moreover, the results underscore the fact that only the process of the invention is gentle to the substrates and the coating layers.

TABLE 1
The production of coatings in a conventional
procedure (comparative experiments C1 and C2)

| | Heating | Surface | | |
|---|---|---|---|---|
| Comparative | time | temperature^{a)} | | Leveling/ |
| experiment | (min) | (° C.) | Blistering | structure |
| C1 | 1 | 102 | No blisters | Severe |
| | | | | orange peel |
| | 2 | 126 | Few small | Orange peel |
| | | | blisters | less |
| | | | | pronounced |
| | 3 | 147 | Many small | Orange peel |
| | | | blisters | slightly |
| | | | | pronounced |
| | 4 | 165^{b)} | Very many | Severe |
| | | | blisters | orange peel |
| C2 | 1 | 97 | No blisters | Severe |
| | | | | orange peel |
| | 2 | 122 | Many small | Orange peel |
| | | | blisters | less |
| | | | | pronounced |
| | 3 | 145 | Very | Orange peel |
| | | | blistery | with |
| | | | | incipient |
| | | | | foaming |
| | 4 | 161^{b)} | Very | Orange peel |
| | | | blistery | with |
| | | | | incipient |
| | | | | foaming |

^{a)}The temperature was reached after the set time; owing to the inertia of the IR lamps, precision regulation was not possible.
^{b)}The melt began to polymerize, and so its viscosity rose even before irradiation.

TABLE 2
The production of coatings in a procedure of
the invention (examples 1 and 2)

| | Heating | Surface | | |
|---|---|---|---|---|
| Example | time | temperature^{a)} | | Leveling/ |
| No. | (min) | (° C.) | Blistering | structure |
| 1 | 45 | 130 | None | Very |
| | | | | slightly |
| | | | | pronounced |
| | | | | orange peel |
| | 90 | 130 | None | Very good |
| | 45 | 140 | None | Good |
| | 90 | 140 | None | Very good |
| 2 | 45 | 130 | None | Very |
| | | | | slightly |
| | | | | pronounced |
| | | | | orange peel |
| | 90 | 130 | None | Very good |
| | 45 | 140 | None | Good |
| | 90 | 140 | None | Very good |

^{a)}The temperature was adjustable via the NIR lamp. It was reached after 20 s and maintained by regulating the lamp.

What is claimed is:

1. A process for producing coatings, adhesive films or seals for primed or unprimed substrates, which comprises
(1) applying at least one free-radically and/or ionically curable coating material and/or adhesive and/or sealing compound comprising
(A) at least one constituent containing on average per molecule at least one group (a) containing at least one bond which can be activated with actinic radiation, and
(B) at least one photoinitiator,
in the form of
(1.1) a water-free and solvent-free liquid or melt,
(1.2) a powder,
(1.3) a powder slurry,
(1.4) a dispersion or a solution in at least one organic solvent, or
(1.5) a dispersion or a solution in an aqueous medium to and/or into the primed or unprimed substrate,
(2) drying the resultant powder slurry layer (1.3) or the resultant layer of a dispersion or a solution (1.4) or (1.5) or causing the resultant layer of the melt (1.1) to solidify or maintaining it in a melted state by heating,
(3) melting, by heating, the resultant solid layer (1.2), (1.3), (1.4) or (1.5), and
(4) first irradiating the liquid layer resulting from step (1) of the process or the melted layer resulting from step (2) or (3)of the process
(4.1) in the liquid or melted state,
(4.2) during solidification, and/or
(4.3) after solidification
with near infrared (NIR) radiation and then curing it with UV radiation and/or electron beams or fully curing it simultaneously with NIR and UV radiation and/or electron beams.

2. The process as claimed in claim 1, wherein the heating in step (2) is carried out with the aid of NIR radiation.

3. The process as claimed in claim 1 or 2, wherein the heating in step (3) is carried out with the aid of NIR radiation.

4. The process as claimed in any of claims 1 to 3, using NIR radiation of a wavelength for which the solid layers (1.2), (1.3), (1.4) and (1.5), the liquids and melts (1.1), and the melts resulting from step (4) are partly transparent.

5. The process as claimed in claim 4, wherein the solid layers (1.2), (1.3), (1.4) and (1.5), the liquids and melts (1.1), and the melts resulting from step (4) absorb from 20 to 80% of the irradiated NIR radiation.

6. The process as claimed in claim 4 or 5, wherein the NIR radiation has a wavelength of from 600 to 1400 nm.

7. The process as claimed in any of claims 1 to 6, wherein the bonds which can be activated with actinic radiation comprise carbon-hydrogen single bonds or carbon-carbon, carbon-oxygen, carbon-nitrogen, carbon-phosphorus or carbon-silicon single bonds or double bonds.

8. The process as claimed in claim 7, wherein the bonds are carbon-carbon double bonds.

9. The process as claimed in claim 8, wherein (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups are used.

10. The process as claimed in claim 9, wherein acrylate groups are used.

11. The process as claimed in any of claims 1 to 10, wherein the constituent (A) is a solid.

12. The process as claimed in claim 11, wherein the constituent (A) is amorphous, partially crystalline, or crystalline.

13. The process as claimed in claim 13, wherein the parent structure of the constituent (A) is of low molecular mass, oligomeric and/or polymeric.

14. The process as claimed in claim 13, wherein the oligomeric and/or polymeric parent structure of the constituent (A) comprises olefinically unsaturated double bonds.

15. The process as claimed in claim 13 or 14, wherein the oligomeric and/or polymeric parent structure of the constituent (A) is derived from random, alternating and/or block, linear, branched, hyperbranched, dendrimeric and/or comb polyaddition resins, polycondensation resins and/or addition (co)polymers of ethylenically unsaturated monomers.

16. The process as claimed in claim 15, wherein the addition (co)polymers are poly(meth)acrylates and/or partially saponified polyvinyl esters and the polyaddition resins and/or polycondensation resins are polyesters, alkyds, polyurethanes, polyester-polyurethanes, polylactones, polycarbonates, polyethers, polyester-polyethers, epoxy resin-amine adducts, polyureas, polyamides or polyimides, especially polyesters, polyester-polyethers, polyurethanes, and polyester-polyurethanes.

17. The process as claimed in any of claims 1 to 16, wherein the groups (a) in the compound (A) are attached to the parent structure by way of urethane, urea, allophanate, ester, ether, and/or amide groups.

18. The process as claimed in claim 17, wherein the groups (a) in the constituent (A) are attached to the parent structure by way of urethane groups.

19. The process as claimed in any of claims 1 to 18, wherein the constituent (A) further comprises at least one reactive functional group (c) which with groups (c) of its own kind and/or with complementary reactive functional groups (d) is able to enter into thermal crosslinking reactions.

20. The process as claimed in any of claims 1 to 19, wherein the constituent (A) further comprises at least one chemically bonded stabilizer (e).

21. The process as claimed in claim 20, wherein a HALS compound is used as chemically bonded stabilizer (e).

22. The process as claimed in claim 21, wherein the 2,2,6,6-tetramethylpiperidine N-oxide-4-oxy group is used as chemically bonded HALS compound (e).

23. The process as claimed in any of claims 1 to 22, wherein the coating material, the adhesive or the sealing compound comprises at least one crosslinking agent (C) containing on average per molecule at least two complementary reactive functional groups (d).

24. The process as claimed in any of claims 1 to 23, wherein the coating material, the adhesive or the sealing compound comprises at least one additive (D).

25. The process as claimed in any of claims 1 to 24, wherein the solvent-free or water-free constituent (A) has a melting range or a melting point in the temperature range from 40 to 130° C.

26. The process as claimed in any of claims 1 to 25, wherein the solvent-free or water-free constituent (A) has a melt viscosity at 130° C. of from 50 to 20 000 mPas.

27. A primed or unprimed substrate comprising at least one coating, at least one adhesive film and/or at least one seal which can be produced by the process as claimed in any of claims 1 to 26.

28. The primed or unprimed substrate as claimed in claim 27, selected from constructions, doors, windows, motor vehicle bodies, furniture or industrial components, including coils, containers, and electrical components.
